(19) United States
(12) Patent Application Publication
(10) Pub. No.: US 2024/0346066 A1
(43) Pub. Date: Oct. 17, 2024

(54) MEDIA COLLECTION GENERATION METHOD AND APPARATUS, ELECTRONIC DEVICE, AND STORAGE MEDIUM

(71) Applicant: BEIJING BYTEDANCE NETWORK TECHNOLOGY CO., LTD., Beijing (CN)

(72) Inventors: Yipeng Huang, Beijing (CN); Chaopeng Liu, Beijing (CN); Shun Hu, Beijing (CN)

(21) Appl. No.: 18/574,686

(22) PCT Filed: Feb. 20, 2023
(86) PCT No.: PCT/CN2023/077264

§ 371 Date: Dec. 27, 2023

(30) Foreign Application Priority Data
Mar. 1, 2022 (CN) 202210195516.0

(51) Int. Cl. G06F 16/48; G06F 3/04817; G06F 3/0482; G06F 3/0488; G06F 16/438; G06F 16/45

(52) U.S. Cl. CPC G06F 16/48; G06F 3/04817; G06F 3/0482; G06F 3/0488; G06F 16/4393; G06F 16/45

(57) ABSTRACT

Embodiments of the present disclosure provide a media collection generation method and apparatus, an electronic device, a storage medium, a computer program product, and a computer program, In the media collection generation method, a plurality of emotion identifiers are displayed in a playing interface for a target piece of media, the emotion identifiers being used for representing preset emotion types; and in response to a first interaction operation on a target emotion identifier, adding the target piece of media to a target emotion media collection corresponding to the target emotion identifier. The emotion identifiers that are preconfigured in the playing interface and triggered by means of an interaction operation implement classification of a target piece of media, and consequently generation of corresponding emotion media collections is achieved, causing a generated emotion media collection to achieve media classification on the basis of on the emotion and feeling of a user, the user experience of a personalized media collection for a user is improved, media collection generation steps and logic are simplified, and media collection generation efficiency is improved.

### CROSS-REFERENCE TO RELATED APPLICATION(S)

The disclosure claims the priority of Chinese Patent Application No. 202210195516.0, filed on Mar. 1, 2022, and entitled “MEDIA COLLECTION GENERATION METHOD AND APPARATUS, ELECTRONIC DEVICE, AND STORAGE MEDIUM”, which is incorporated in its entirety herein by reference.

### FIELD

Embodiments of the disclosure relate to the field of Internet technology, and in particular to a media collection generation method and apparatus, an electronic device, a storage medium, a computer program product, and a computer program.

### BACKGROUND

The media collection function in a multimedia application (APP) is one of common basic functions. Taking music multimedia applications as an example, users can manually select, favorite, and classify their favorite songs to create custom playlists that satisfy their needs, thereby achieving the classification and playback of songs.

In the related art, the solution of classifying and favoriting media in the multimedia application (APP) to create media collections is typically based on user-defined playlists. Classification is performed based on media information, for example, songs from different artists and albums are added to corresponding playlists to create custom playlists.

However, in the related art, the solution of generating the media collections based on media information involves complex classification logic, which fails to satisfy the requirements of the users for intuitive-emotional-feeling-based media classification, and is low in efficiency of performing media classification to generate the media collections.

### SUMMARY

Embodiments of the disclosure provide a media collection generation method and apparatus, an electronic device, a storage medium, a computer program product, and a computer program so as to solve the problems that in the related art, a solution of generating media collections based on media information involves complex classification logic for different types of media, which fails to satisfy the requirements of users for intuitive-emotional-feeling-based song classification, and is low in efficiency of performing media classification to generate the media collections.

In a first aspect, an embodiment of the disclosure provides a media collection generation method, including:
displaying a plurality of state identifications within a playback interface of target media, the state identifications being used for representing preset state types; and adding, in response to a first interactive operation for a target state identification, the target media to a target state media collection corresponding to the target state identification.

In a second aspect, an embodiment of the disclosure provides a media collection generation apparatus, including:
a display module, configured to display a plurality of state identifications within a playback interface of target media, the state identifications being used for representing preset state types; and
a processing module, configured to add, in response to a first interactive operation for a target state identification, the target media to a target state media collection corresponding to the target state identification.

In a third aspect, an embodiment of the disclosure provides an electronic device, including:
a processor, and a memory which is in communication connection with the processor.

The memory stores computer executable instructions.

The processor executes the computer executable instructions stored on the memory so as to implement the media collection generation method in the first aspect and various possible designs in the first aspect.

In a fourth aspect, an embodiment of the disclosure provides a computer-readable storage medium. The computer-readable storage medium stores computer executable instructions. When a processor executes the computer executable instructions, the media collection generation method according to the first aspect and various possible designs in the first aspect is implemented.

In a fifth aspect, an embodiment of the disclosure provides a computer program product, including a computer program. The computer program, when executed by a processor, implements the media collection generation method according to the first aspect and various possible designs in the first aspect.

In a sixth aspect, an embodiment of the disclosure provides a computer program. The computer program, when executed by a processor, implements the media collection generation method according to the first aspect and various possible designs in the first aspect.

According to the media collection generation method and apparatus, the electronic device, the storage medium, the computer program product, and the computer program provided in the embodiments, the plurality of state identifications are displayed within the playback interface of the target media, and the state identifications are used for representing the preset state types; and in response to the first interactive operation for the target state identification, the target media is added to the target state media collection corresponding to the target state identification. The state identifications preset within the playback interface are triggered by the interactive operations so as to realize target media classification, such that the corresponding state media collections are generated, and media classification on the generated state media collections can be realized based on the emotional feelings of the user, thereby improving the use experience of the custom media collections for the user, simplifying media collection generation steps and logics, and improving the media collection generation efficiency.

### BRIEF DESCRIPTION OF THE DRAWINGS

In order to describe the technical solutions in embodiments of the disclosure or the related art more clearly, the accompanying drawings required for describing the embodiments or the related art will be briefly introduced below. Apparently, the accompanying drawings described below are some embodiments of the disclosure, and a person of ordinary skill in the art can also derive other accompanying drawings from these accompanying drawings without creative efforts.

FIG. 1 is a schematic diagram of a process of adding a song to a playlist in the related art;

FIG. 2 is a first schematic flowchart of a media collection generation method according to an embodiment of the disclosure;

FIG. 3 is a schematic diagram of a playback interface according to an embodiment of the disclosure;

FIG. 4 is a schematic diagram of emotion identifications according to an embodiment of the disclosure;

FIG. 5 is a flowchart of an implementation for step S102 in the embodiment shown in FIG. 2;

FIG. 6 is a schematic diagram of a process of adding a target song to a corresponding target emotion playlist according to an embodiment of the disclosure;

FIG. 7 is a schematic diagram of a custom playlist according to an embodiment of the disclosure;

FIG. 8 is a second schematic flowchart of a media collection generation method according to an embodiment of the disclosure;

FIG. 9 is a schematic diagram of a process of displaying emotion identifications in response to a fourth interactive operation according to an embodiment of the disclosure;

FIG. 10 is a schematic diagram of another process of displaying emotion identifications in response to a fourth interactive operation according to an embodiment of the disclosure;

FIG. 11 is a schematic diagram of selecting a target emotion identification based on a long-press operation according to an embodiment of the disclosure;

FIG. 12 is a schematic diagram of editing a target emotion playlist according to an embodiment of the disclosure;

FIG. 13 is a third schematic flowchart of a media collection generation method according to an embodiment of the disclosure;

FIG. 14 is a schematic diagram of an emotion playlist homepage according to an embodiment of the disclosure;

FIG. 15 is a schematic diagram illustrating the access of an emotion playlist homepage by other users according to an embodiment of the disclosure;

FIG. 16 is a structural block diagram of a media collection generation apparatus according to an embodiment of the disclosure;

FIG. 17 is a structural schematic diagram of an electronic device according to an embodiment of the disclosure; and

FIG. 18 is a schematic diagram of a hardware structure of an electronic device according to an embodiment of the disclosure.

### DETAILED DESCRIPTION OF EMBODIMENTS

In order to have a clearer understanding of the objectives, technical solutions and advantages of embodiments of the disclosure, the technical solutions in the embodiments of the disclosure are clearly and completely described in conjunction with the accompanying drawings in the embodiments of the disclosure, and it is apparent that the described embodiments are only a part rather all of embodiments of the disclosure. Based on the embodiments of the disclosure, all other embodiments obtained by those of ordinary skill in the art without contributing creative work shall fall within the scope of protection of the disclosure.

The application scenarios for the embodiments of the disclosure are described below:

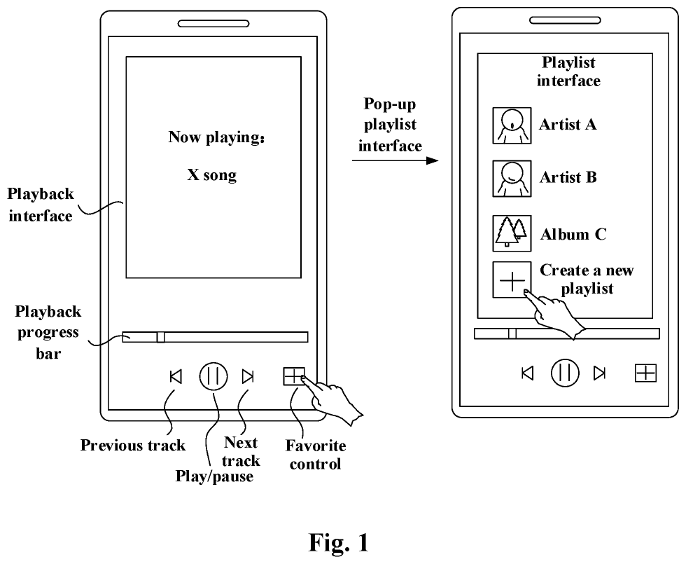

A media collection generation method provided in an embodiment of the disclosure may be applied to application scenarios for generating media collections in various multimedia APPs, such as an application scenario for generating movie collections in video APPs, and an application scenario of generating playlists in music APPs. The process of generating playlists in a music APP is exemplarily described, where the playlists are one form of implementing media collections. FIG. 1 is a schematic diagram of a process of adding a song to a playlist in the related art. As shown in FIG. 1, taking a music APP as an example, a song playback interface is provided with playback controls such as play/pause, previous track, next track, and a playback progress bar, and a favorite control for collecting the current song. When the currently playing song is required to be favorited to a specified playlist, a user needs to tap on the favorite control, and then selects a playlist name from a new pop-up playlist interface, for example, as shown in “Artist A”, “Artist B”, and “Album C” in FIG. 1, by tapping on any one of those options, the currently playing song is added to a playlist corresponding to the playlist name; and alternatively, by tapping on a “Create a new playlist”, a playlist name is customized as required, and through the above steps, the current song is added to the playlist with the playlist name, thereby finishing the playlist generation process. Alternatively, in a simpler approach, when the user taps on the favorite control, the song is directly marked as a “Favorite Song” (usually represented by a heart-shaped icon in this case) without further differentiation, thereby generating a “General Favorite Playlist”.

In the application scenario where the playlist is generated based on operation instructions of the user, the media collection generation method provided by the APP in the related art usually adopts the above method: based on the playlist name customized by the user, mapping is performed according to the relationship between song information and the playlist name to add the song to the corresponding playlist, thereby forming the custom playlist.

However, in practical use, there are the following problems:

Firstly, in the process shown in FIG. 1, before favoriting the current song to the corresponding playlist, the user needs to manually create a playlist name, and then favorite the song to the corresponding playlist according to the matching relationship between the playlist name and the song information. For example, the target song to be favorited is performed by Artist A, the target song is added to the playlist named after Artist A; and alternatively, if the target song to be favorited is from Album B, the target song is added to the playlist named after Album B. The custom playlist needs to be manually created in advance, which leads to an increase in operation steps in the playlist generation process, causing use inconvenience for the user.

In addition, the above method for generating the playlist according to the matching relationship between the playlist name and the song information is essentially a logic-rule-based song classification method. However, the unclear song information will cause difficulties in classification for the user. For example, when the user needs to favorite and add target media to the playlist, which is a niche song without accurate song information, the user cannot determine, based on the logic-rule-based song classification method in the related art, which playlist the target song is added, causing use inconvenience for the user.

In order to solve the above problems, an embodiment of this application provides a media collection generation method. Songs are classified based on intuitive emotional feelings of the user, thereby creating emotion-based playlists. The songs are classified based on the emotional feelings of the user, so as to overcome the logical barriers in song classification when the song information is inaccurate, thereby improving the efficiency of song classification and playlist generation.

An executive body of the media collection generation method provided in this embodiment may be an electronic device, such as a smart phone, a computer, or another terminal device. More specifically, the media collection generation method is applied to applications running in the terminal device (e.g., APP, and browsers), thereby generating playlists in the applications. In addition, the media collection generation method provided in this embodiment may also be used to classify media such as movies and short videos so as to generate corresponding media collections.

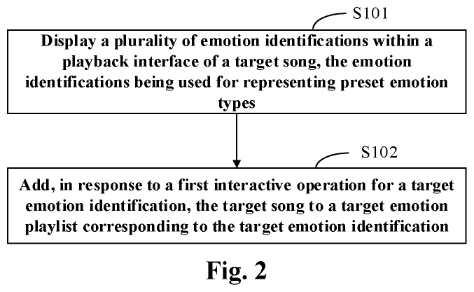

FIG. 2 is a first schematic flowchart of a media collection generation method according to an embodiment of the disclosure. This embodiment is introduced with a terminal as an executive body. The steps of this embodiment are exemplarily described with the process of generating playlists in a music APP, where songs serve as an exemplary implementation form of media, and playlists serve as an exemplary implementation form of media collections. The media collection generation method includes:

Step S101: a plurality of emotion identifications are displayed within a playback interface of a target song, and the emotion identifications are used for representing preset emotion types.

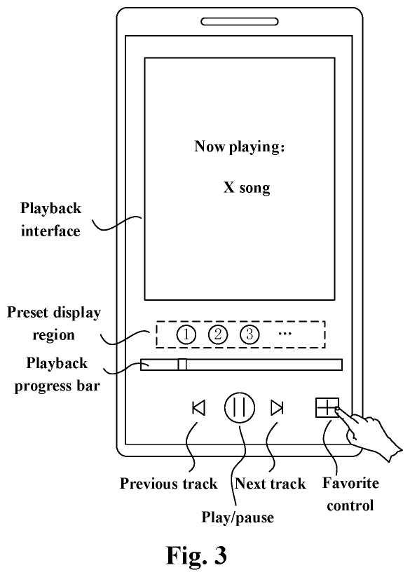

Exemplarily, FIG. 3 is a schematic diagram of a playback interface according to an embodiment of the disclosure. As shown in FIG. 3, exemplarily, the playback interface is a playback interface of a music APP running in a terminal device, and the playback interface displays a currently playing target song (i.e., target media, shown as Song X in the figure). Common playback controls such as play/pause, previous track, next track, and a playback progress bar are set within the playback interface. Additionally, a plurality of emotion identifications (as indicated by \textcircled{1}, \textcircled{2}, \textcircled{3} in the figure) are displayed within a preset display region of the playback interface. Each emotion identification corresponds to an emotion type. For example, the emotion identification \textcircled{1} corresponds to the emotion of happiness, and the emotion identification \textcircled{2} corresponds to the emotion of sadness. In a possible implementation, the playback interface serves as a main interface and is loaded and displayed after the music APP runs. The emotion identifications may be set as controls within the playback interface, or may be displayed as overlays on the top of the playback interface. The various controls and emotion identifications within the playback interface can be triggered based on operation instructions of the user, so as to perform corresponding actions.

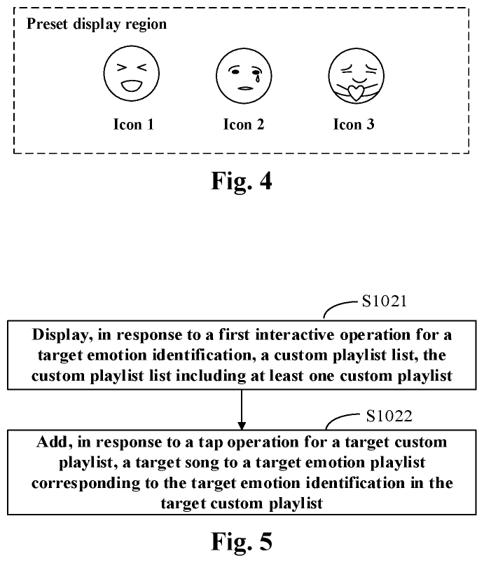

Exemplarily, the emotion identifications are icons representing the preset emotion types. FIG. 4 is a schematic diagram of emotion identifications according to an embodiment of the disclosure. As shown in FIG. 4, the emotion identifications, for example, include: an emoticon representing happiness (shown as Icon 1 in the figure), an emoticon representing sadness (shown as Icon 2 in the figure), an emoticon representing being touched (shown as Icon 3 in the figure). The user marks a target song as a song in the corresponding emotion category by tapping on different emotion identifications. Further, the emotion identifications may also include various emotion types expressing excitement, romance, relaxation, etc., which are not enumerated.

Step S102: in response to a first interactive operation for a target emotion identification, the target song is added to a target emotion playlist corresponding to the target emotion identification.

Exemplarily, when the user needs to classify, favorite, and add the current target song (e.g., target media, which may be in a playing or non-playing state) to a playlist, the corresponding emotion identification may be selected according to the emotional feeling of the user, such as the emoticon representing sadness, and the emoticon representing being touched, thereby instructing the terminal device to perform corresponding actions. The operation of selecting the corresponding emotion identification is the first interactive operation, more specifically, such as a tap operation. The terminal device responds to the first interactive operation after receiving the first interactive operation, thereby finishing the process of marking the target song and adding the target song to the playlist. Specifically, the emotion playlist (i.e., an emotion media collection) serves as a preset queue, which is empty in an initial state. When the terminal device receives the first interactive operation, an emotion playlist identification is determined based on an emotion identification indicated by the first interactive operation, such that a target emotion playlist (i.e., a target emotion media collection) corresponding to the emotion playlist identification is determined. Then, the terminal device adds a song identification corresponding to the target song to a corresponding queue of the target emotion playlist. In the subsequent playback of the target emotion playlist, based on a set playback order, song identifications are read from the corresponding queue of the target emotion playlist, thereby playing the corresponding songs.

In this embodiment, because the emotion identifications are preset within the playback interface, the user can achieve emotion classification on the target song and addition of the target song to the corresponding classified playlist with one operation (i.e., first interactive operation), without creating a playlist name in advance, thereby reducing the steps of playlist creating. Moreover, song classification is performed based on the intuitive emotional feelings instead of a conventional logic-rule-based media collection generation method, and therefore there is no need for song information to determine which playlist is matched with the song, thereby eliminating logical barriers in song classification, enhancing the smoothness of song classification for the user, aligning better with user habits, and improving user experience.

In a possible implementation, in order to further improve the subdivision of the generated playlist and satisfy different user requirements, this embodiment provides, on the basis of the emotion playlist in the above steps and in conjunction with conventional custom playlists (i.e., custom media collections), a method for adding the target song to the target emotion playlist in a more subdivided manner. Exemplarily, as shown in FIG. 5, specific implementation steps of step S102 include:

Step S1021: in response to the first interactive operation for the target emotion identification, a custom playlist list is displayed, which includes at least one custom playlist.

Step S1022: in response to the tap operation for a target custom playlist, the target song is added to a target emotion playlist corresponding to the target emotion identification in the target custom playlist.

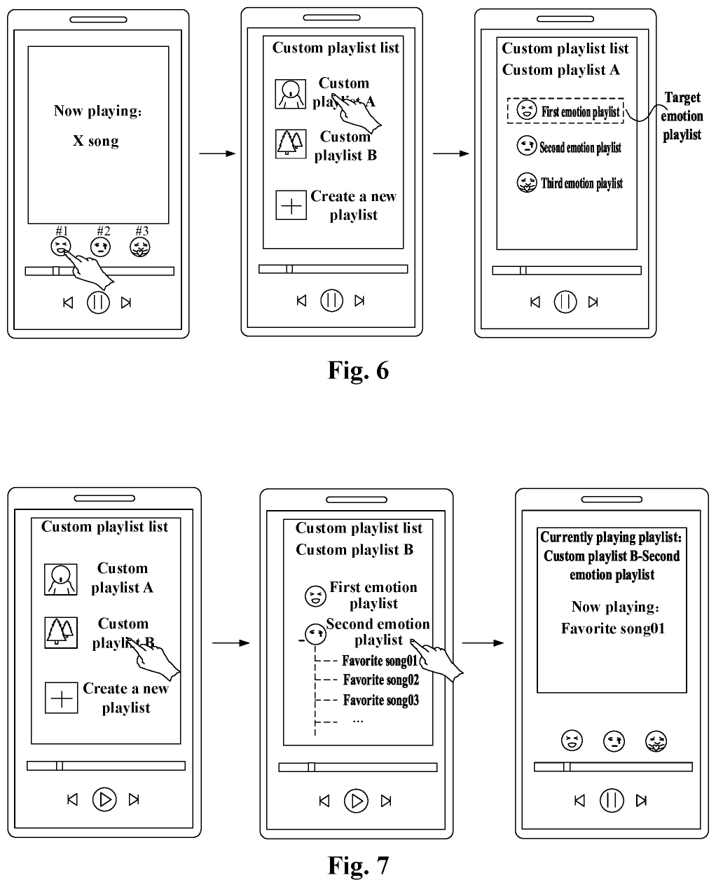

FIG. 6 is a schematic diagram of a process of adding a target song to a corresponding target emotion playlist according to an embodiment of the disclosure. As show in FIG. 6, the first interactive operation, for example, may be a tap operation, and a playback interface includes an emotion identification #1, an emotion identification #2, and an emotion identification #3, respectively representing three different emotion types. When the terminal device receives the user tap operation on the emotion identification #1 (i.e., the target emotion identification), the playback interface displays a custom playlist list. The custom playlist list includes at least one custom playlist (a custom playlist A and a custom playlist B shown in the figure). The custom playlist is a playlist that the user adds and customizes. The custom playlist may include a plurality of sub-playlists, namely, emotion playlists. For example, the custom playlist A includes three emotion playlists, which are a first emotion playlist corresponding to the emotion of happiness, a second emotion playlist corresponding to the emotion of sadness, and a third emotion playlist corresponding to the emotion of being touched. Exemplarily, the number of emotion playlists within the corresponding custom playlists may not be consistent. The custom playlist may be a valid playlist with added songs, or an empty playlist with only a set playlist name but without songs added.

Further, the user selects, based on a specific classification logic such as artist information and album information, a target custom playlist matched with the current target song from the custom playlists. Then, the terminal device adds the target song to a target emotion playlist (the first emotion playlist in the figure) corresponding to the target emotion identification within the target custom playlist, that is, a mapping relationship between the identification of the target song and a two-dimensional array composed of the custom playlist and the emotion playlist is established. Therefore, the process of adding the target song to the playlist is completed. When there is no corresponding target emotion playlist within the target custom playlist, an empty target emotion playlist corresponding to the target emotion identification is first automatically and newly created, and then, the target song is added to the target emotion playlist.

Further, exemplarily, after (or before) adding the target song to the target emotion playlist corresponding to the target emotion identification within the target custom playlist, playlist playback can be performed based on the custom playlist including the emotion playlists. Specifically, this embodiment further includes steps:
in response to a second interactive operation for the target custom playlist, at least one emotion playlist belonging to the target custom playlist is displayed; and in response to the tap operation for the target emotion playlist within the at least one emotion playlist, favorite songs (i.e., media within the collection) belonging to the clicked target emotion playlist are played.

FIG. 7 is a schematic diagram of custom playlists according to an embodiment of the disclosure. As shown in FIG. 7, the second interactive operation, for example, may be a tap operation for a target custom playlist. After the target custom playlist within a custom playlist list is clicked (a custom playlist B shown in the figure), emotion playlists (a first emotion playlist and a second emotion playlist shown in the figure) within the target custom playlist are displayed. Optionally, favorite songs (a favorite song 01, a favorite song 02, a favorite song 03, etc.) within the emotion playlists are displayed as well. After the user taps on the target emotion playlist (the second emotion playlist shown in the figure), the terminal device plays favorite songs in the second emotion playlist within the emotion playlist B. Exemplarily, relevant playlist information and song information are displayed on the playback interface as well.

In this embodiment, by combining the custom playlists and the emotion playlists, on the basis of conventional playlists, the playlists can be further subdivided based on the emotional feelings of the user for songs so as to realize, for example, classification of songs based on emotions within the same album playlist or the playlist of a particular artist, thereby enhancing the flexibility of playlist generation and playback and improving use experience for the user.

In this embodiment, the plurality of emotion identifications are displayed within the playback interface of the target song, and are used for representing the preset emotion types; and in response to the first interactive operation for the target emotion identification, the target song is added to the target emotion playlist corresponding to the target emotion identification. By triggering the emotion identifications preset within the playback interface through the interactive operations, target song classification is realized, such that the corresponding emotion playlists are generated, which allow the songs within the generated emotion playlists to be classified based on the emotional feelings of the user, thereby improving the use experience of the custom playlists for the user, simplifying playlist generation steps and logics, and improving the playlist generation efficiency.

The media collection generation method provided in this embodiment may be applied to the scenario for playlist generation for music media, and may also be applied to scenarios for corresponding video playlist and collection generation for other media such as videos, thereby generating media collections corresponding to video media. The specific implementations and technical effects are similar to the method and effects of music playlist generation in this embodiment, which are not further described herein.

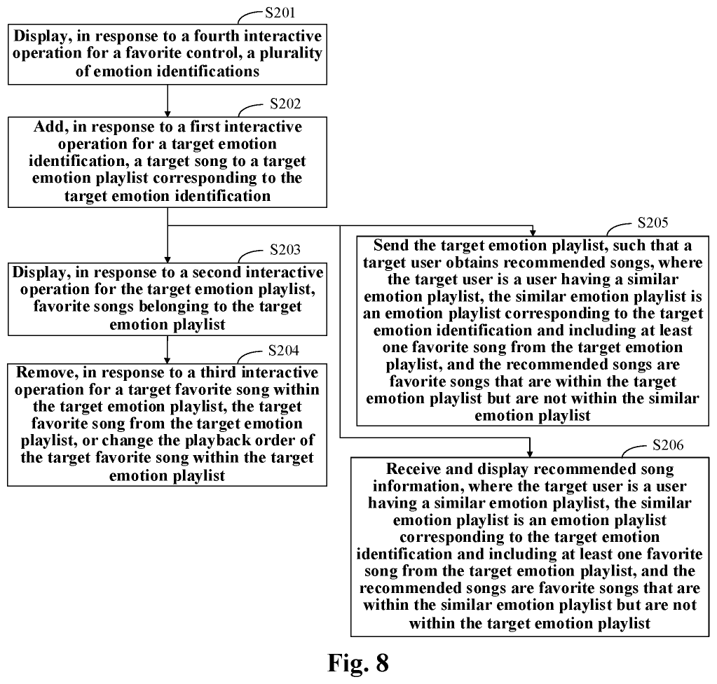

FIG. 8 is a second schematic flowchart of a media collection generation method according to an embodiment of the disclosure. In this embodiment, the interaction process for generating and playing the target emotion playlist is further refined based on the embodiment shown in FIG. 2, and steps for editing the target emotion playlist are added. Exemplarily, the terminal device includes a touchscreen for user-machine interaction, and the user inputs the interactive operations through the touchscreen. The playback interface is provided with a favorite control, which is used to favorite the target song after being triggered (for example, after the user performs a tap on the touchscreen). The media collection generation method provided in this embodiment of the disclosure includes:

Step S201: in response to a fourth interactive operation for the favorite control, a plurality of emotion identifications are displayed.

Exemplarily, the favorite control is an icon or button used to favorite songs, and in the related art, the favorite control is typically represented by a “heart-shaped” icon. In the related art, the usage of the favorite control is that when the user taps on the favorite control, the favorite control changes color (for example, turns red), which indicates that the song has been favorited. In this embodiment, the fourth interactive operation for the favorite control is different from a trigger operation corresponding to the favorite control. Exemplarily, the trigger operation for the favorite control is a (single) tap, and the fourth interactive operation includes one of the following: long press, double tap, and swipe.

In the default state of the playback interface in this embodiment, emotion identifications are not displayed. The terminal device receives and responds to the fourth interactive operation different from the trigger operation for the favorite control, and then the plurality of emotion identifications are displayed within a preset display region, thereby achieving the concealment of the emotion identifications and enhancing the overall aesthetics of the playback interface.

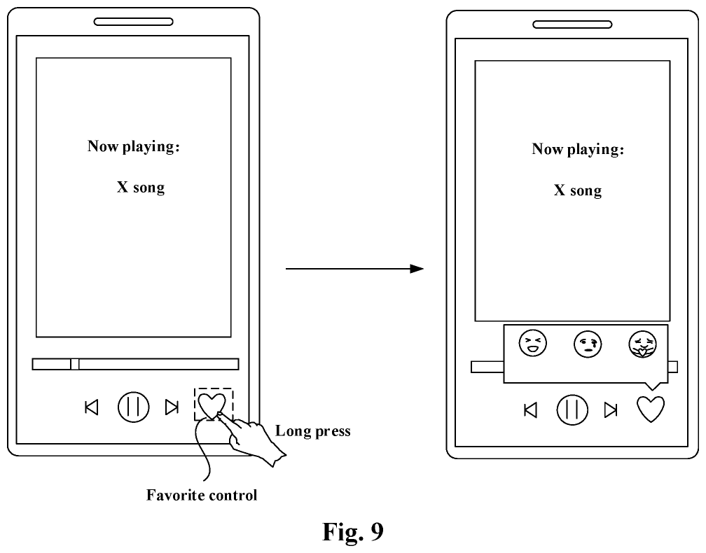

FIG. 9 is a schematic diagram of a process of displaying emotion identifications in response to a fourth interactive operation according to an embodiment of the disclosure. As shown in FIG. 9, the fourth interactive operation is a long-press operation for the favorite control (represented by a heart-shaped icon in the figure). In a possible case, after the user inputs the long-press operation for the favorite control, three emoticons, namely an emoticon A, an emoticon B, and an emoticon C, are displayed within a preset display region above the favorite control. Then, the user can perform corresponding operations for the emoticon A, the emoticon B, and the emoticon C to achieve corresponding classification functions (i.e., creating corresponding emotion playlists).

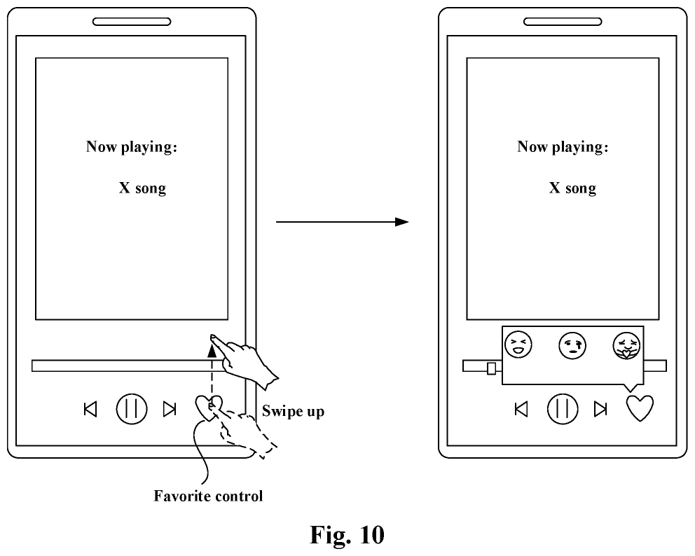

FIG. 10 is a schematic diagram of another process of displaying emotion identifications in response to a fourth interactive operation according to an embodiment of the disclosure. As shown in FIG. 10, the fourth interactive operation is a swipe operation for the favorite control. In a possible case, after the user inputs the swipe operation for the favorite control, three emoticons, namely an emoticon A, an emoticon B, and an emoticon C, are displayed within a preset display region above the favorite control. Then, the user can perform corresponding operations for the emoticon A, the emoticon B, and the emoticon C to achieve corresponding classification functions (i.e., creating corresponding emotion playlists).

In another possible case, after the user performs a single-tap operation for the favorite control, the favorite control changes color while no emoticon is displayed, and the terminal device directly adds the current target song to a general favorites playlist. In this embodiment, by setting the fourth interactive operation different from the trigger operation of the favorite control, the emotion identifications are displayed. By combining a conventional triggering method for the favorite control, the purpose of triggering different song classification methods (e.g., general playlists and emotion playlists) through different operations, thereby realizing a diversified playlist generation method.

Step S202: in response to a first interactive operation for a target emotion identification, the target song is added to a target emotion playlist corresponding to the target emotion identification.

Exemplarily, based on the above steps, after the step of displaying the emotion identifications triggered through the fourth interactive operation, the terminal device continues to receive and respond to the first interactive operation input by the user for indicating the target emotion playlist.

The first interactive operation is determined based on the fourth interactive operation. Exemplarily, when the fourth interactive operation is the long-press operation, for example, after long-pressing for one second, the emotion identifications are displayed within the preset display region. In a possible implementation, the corresponding first interactive operation may be the swipe operation, that is, based on the touchscreen, the position of the favorite control is swiped to the emotion identification position within the preset display region through the gesture, thereby selecting the target emotion identification, and adding the target song to the target emotion playlist corresponding to the target emotion identification. Meanwhile, in the process of performing the first interactive operation, specifically, in the process of swiping the position of the favorite control to the emotion identification position within the preset display region through the gesture, if the user cancels the swipe gesture (e.g., the finger leaving the surface or swiping in another direction) before the swipe gesture reaches the emotion identification, the emotion identification is not displayed any more, thereby realizing rapid concealment of the emotion identification. In another possible implementation, the corresponding first interactive operation may be the tap operation, that is, after the emotion identifications are displayed within the preset display region through the long-press operation, the emotion identifications are in a constant display state (that is, after the finger performs the long-press operation on the corresponding position of the favorite control on the touchscreen, the emotion identifications are still displayed even after the finger leaves the touchscreen), and then, the user taps on the emotion identification within the preset display region through the gesture, thereby selecting the target emotion identification, and adding the target song to the target emotion playlist corresponding to the target emotion identification.

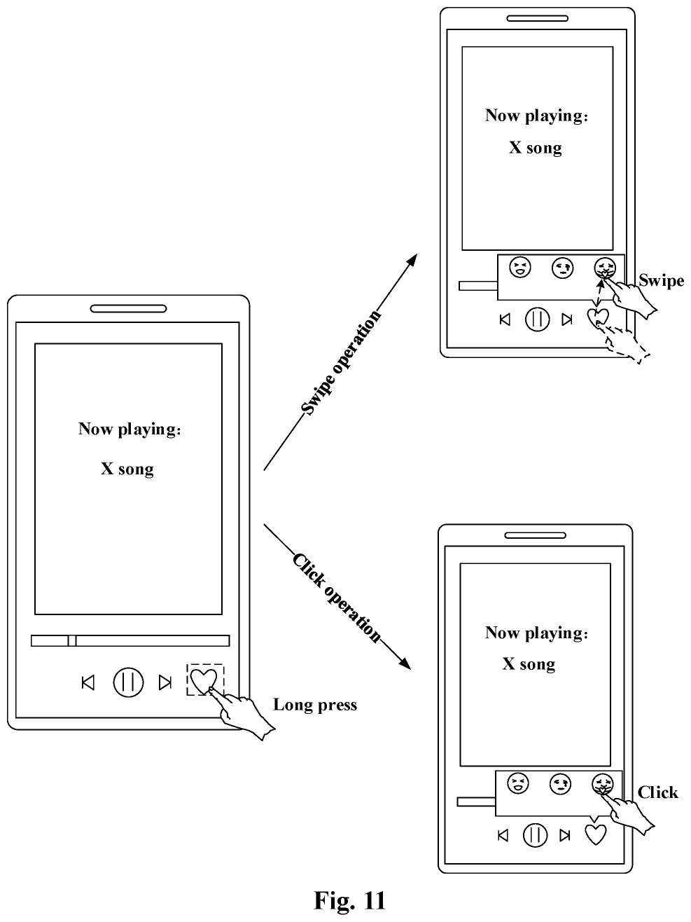

FIG. 11 is a schematic diagram of selecting a target emotion identification based on a long-press operation according to an embodiment of the disclosure. As shown in FIG. 11, after tapping on a favorite control (a heart-shaped icon shown in the figure) through the long-press gesture, in a possible implementation, an emotion identification A, an emotion identification B, and an emotion identification C are displayed above the heart-shaped icon, the user swipes towards the emotion identification C through the gesture, and therefore, the emotion identification C is selected as the target emotion identification. In another possible implementation, the emotion identification A, the emotion identification B, and the emotion identification C are displayed on a right side of the heart-shaped icon and are in a constant display state, if the user taps on the emotion identification B through the tap gesture, the emotion identification B is selected as the target emotion identification. If the user taps on another empty position, the emotion identification A, the emotion identification B, and the emotion identification C are hidden.

Exemplarily, when the fourth interactive operation is the swipe operation, the emotion identifications may be displayed in the constant display manner within the preset display region. Correspondingly, the first interactive operation may be the tap operation, that is, the user taps on the emotion identification within the preset display region through the gesture, thereby selecting the target emotion identification, and this process is similar to the method for selecting the target emotion identification through the tap operation in the scenario of the long-press operation, which is not further described herein. Reference may be made to the implementation for selecting the target emotion identification through the tap operation in the embodiment shown in FIG. 11.

Step S203: in response to a second interactive operation for the target emotion playlist, favorite songs belonging to the target emotion playlist are displayed.

Exemplarily, after the target song is added to the target emotion playlist through the above step, the favorite songs within the target emotion playlist can be displayed through the second interactive operation, such that the user can play and modify the favorite songs within the emotion playlist, where the favorite songs include the target song added in the above step and other songs added to the target emotion playlist, namely all songs within the target emotion playlist. Specifically, the second interactive operation may be the tap operation for a playlist control within an APP, where the playlist control may be set within the playback interface, or another interface. By triggering the playlist control, one or more of custom playlists, emotion playlists, and general favorite playlists can be displayed, and through a secondary tap operation or a direct display method, favorite songs within various playlists are displayed. A specific implementation of the playlist control may be set as required, which is not further described herein.

Step S204: in response to a third interactive operation for the target favorite song within the target emotion playlist, the target favorite song is removed from the target emotion playlist, or the playback order of the target favorite song within the target emotion playlist is changed.

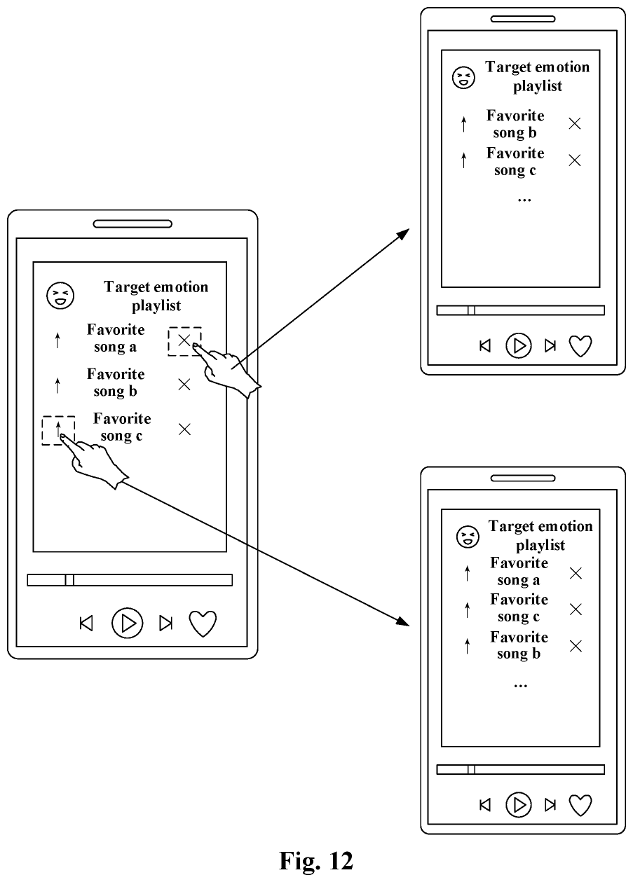

Exemplarily, the third interactive operation is an operation for editing the favorite songs within the target emotion playlist. Specifically, FIG. 12 is a schematic diagram of editing a target emotion playlist according to an embodiment of the disclosure. As shown in FIG. 12, after favorite songs within the target emotion playlist are displayed, delete controls and reordering controls are set at corresponding positions of the favorite songs (a favorite song a, a favorite song b, a favorite song c, etc. shown in the figure) within the target emotion playlist. Specifically, refer to an illustrative solution in FIG. 12, on the left side of each favorite song, there is the reordering control (denoted by “T” in the figure) to adjust the order of the favorite songs. On the right side of each favorite song, there is the delete control (denoted by “x” in the figure) to remove the favorite song from the current target emotion playlist. The third interactive operation may be a tap operation for the delete control or the reordering control. The terminal device performs the corresponding action after receiving and responding to the tap operation on the delete control or the reordering control for the target favorite song, thereby removing the target favorite song from the target emotion playlist, or changing the playback order of the target favorite song within the target emotion playlist. A specific implementation method and principle for changing the playback order of the target favorite song and removing the target favorite song from the target emotion playlist are well-known related arts for those skilled in the art, which are not further described herein.

Step S205: the target emotion playlist is sent, such that a target user obtains recommended songs (i.e., recommended media), where the target user is a user having a similar emotion playlist, the similar emotion playlist is an emotion playlist corresponding to the target emotion identification and including at least one favorite song from the target emotion playlist, and the recommended songs are favorite songs that are within the target emotion playlist but are not within the similar emotion playlist.

Further, for the emotion playlists generated for the user based on the above step, because the emotion playlists are generated based on the emotional perception of the user, the emotion playlists have certain reference functions and propagative characteristics for users with similar emotional perception traits. In the application scenario of Internet products, by recommending the emotion playlists from different users, the advantages of enhancing the diversity of the playlists for the users and improving the accuracy of song recommending within the APP can be achieved.

Specifically, after the target emotion playlist is obtained, the terminal device synchronizes, through the running APP, the target emotion playlist to a user account logged into the APP on a server. Then, based on the favorite songs within the target emotion playlist, the server determines, by searching for emotion playlists synchronized within other user accounts, emotion playlists corresponding to the target emotion identification and including at least one favorite song within the target emotion playlist, namely, similar emotion playlists. Further, the user having the similar playlist is determined as the target user, namely, the user with emotion playlists of the same emotion type including several same songs. Then, the favorite songs within the target emotion playlist but not within the similar emotion playlist are determined as recommended songs to be pushed to the target user, such that the target user obtain the recommended songs. Specifically, for example, a target emotion playlist uploaded by a user user_1 (an account) includes an emotion playlist A representing the emotion of happiness and an emotion playlist B representing the emotion of sadness, where the emotion playlist A includes favorite songs [A1, A2, and A3], and the emotion playlist B includes favorite songs [B1, B2, and B3]. The server performs a search based on the favorite songs within the target emotion playlist, and finds that an emotion playlist A representing the emotion of happiness for a user user_2 (an account) includes favorite songs [A3, A4, and A5], that is, the emotion playlist A in user_2 includes one favorite song A3 the same as the song within the emotion playlist A from the target emotion playlist, and in this case, the server determines the emotion playlist of user_2 as a similar emotion playlist, meanwhile, determines user_2 as the target user, and pushes the favorite songs A1 and A2 within the emotion playlist A corresponding to the target emotion playlist to the user user_2, such that the user user_2 obtains the songs recommended by the user having the similar emotional perception traits.

There may be one or more target emotion playlists. The target emotion playlist may be an emotion playlist obtained through the above steps and including the target song, and may also be an emotion playlist generated in the previous plurality of emotion playlist generation processes. More specifically, exemplarily, the target emotion playlists sent by the terminal device may be all emotion playlists of the user logging into the APP running on the terminal device.

Step S206: recommended song information from the target user is received and displayed, where the target user is a user having a similar emotion playlist, the similar emotion playlist is an emotion playlist corresponding to the target emotion identification and including at least one favorite song from the target emotion playlist, and the recommended songs are favorite songs that are within the similar emotion playlist but are not within the target emotion playlist.

Further, by combining the step of sending the target emotion playlist to the server introduced in step S205, this embodiment may further include the step of receiving and displaying the recommended song information (i.e., recommended media information). Specifically, after the user at least adds the song to the emotion playlist corresponding to one emotion identification, for example, after step S202 is performed, the target emotion playlist is synchronized to the server, and then, exemplarily, the server searches, based on the favorite songs within the target emotion playlist, for favorite songs within emotion playlists uploaded by other users, and determines the emotion playlist corresponding to the target emotion identification and including at least one favorite song within the target emotion playlist, namely the similar emotion playlist. Further, the user having the similar emotion playlist is determined as the target user. Then, the favorite songs within the similar emotion playlist but not within the target emotion playlist are determined as recommended songs. Specifically, for example, the target emotion playlist uploaded by the user user_1 (an account) includes an emotion playlist A representing the emotion of happiness and an emotion playlist B representing the emotion of sadness, where the emotion playlist A includes favorite songs [A1, A2, and A3], and the emotion playlist B includes favorite songs [B1, B2, and B3]. The server performs a search based on the favorite songs within the target emotion playlist, and finds that an emotion playlist B representing the emotion of sadness for the user user_2 (an account) includes favorite songs [B3, B4, and B5], that is, the emotion playlist B in user_2 includes one favorite song B3 the same as the song within the emotion playlist B from the target emotion playlist, and in this case, the server determines the emotion playlist B of user_2 as a similar emotion playlist, meanwhile, determines user_2 as the target user, and pushes the favorite songs B4 and B5 within the emotion playlist B to the user user_1, such that the user user_1 obtains the songs recommended by the user having the similar emotional perception traits.

Further, recommended song information representing the recommended songs is sent to the terminal device, and after the terminal device obtains the recommended song information, corresponding contents are displayed on the display interface of the emotion playlist based on the recommended song information, such as the names of the recommended songs, target users corresponding to the recommended songs, and the number of the target users. Therefore, the current user obtains the songs recommended by the user having the similar emotional perception traits, thereby enriching the playlist of the current user, and improving APP song recommending accuracy.

Step S205 and step S206 provided in this embodiment are independent steps, corresponding to the same executive body. Step S205 and step S206 may be separably performed, and may also be performed in any order, which is not specifically limited herein.

It should be noted that steps S205 and S206 in this embodiment are implemented based on preset emotion identifications and corresponding emotion media collections. The conventional method for generating playlists through custom collections and custom classification cannot realize accurate playlist synchronization due to the fact that the names of the playlists are defined by the users. For example, a playlist representing the emotion of sadness may be named “sadness” by the user user_1, “bad mood” by the user user_2, and “depression” by a user user_3, and in this case, it is difficult to realize accurate song classification, making it impossible in accurate song recommendation in the steps of this embodiment. Compared with playlists generated through the conventional method of custom collections and custom classification, the song recommendation solution based on the emotion identifications and the emotion playlists in this embodiment can effectively improve recommendation accuracy.

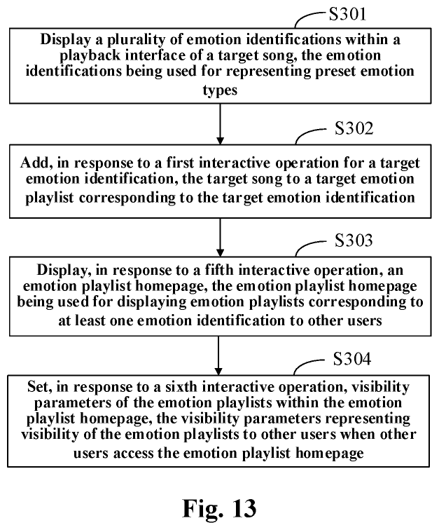

FIG. 13 is a third schematic flowchart of a media collection generation method according to an embodiment of the disclosure. Based on the embodiment shown in FIG. 2, the steps of displaying and editing an emotion playlist homepage are added in this embodiment. The media collection generation method provided in this embodiment of the disclosure includes:

Step S301: a plurality of emotion identifications are displayed within a playback interface of a target song, and the emotion identifications are used for representing preset emotion types.

Step S302: in response to a first interactive operation for a target emotion identification, the target song is added to a target emotion playlist corresponding to the target emotion identification.

Step S303: in response to a fifth interactive operation, an emotion playlist homepage is displayed, and the emotion playlist homepage is used for displaying emotion playlists corresponding to at least one emotion identification to other users.

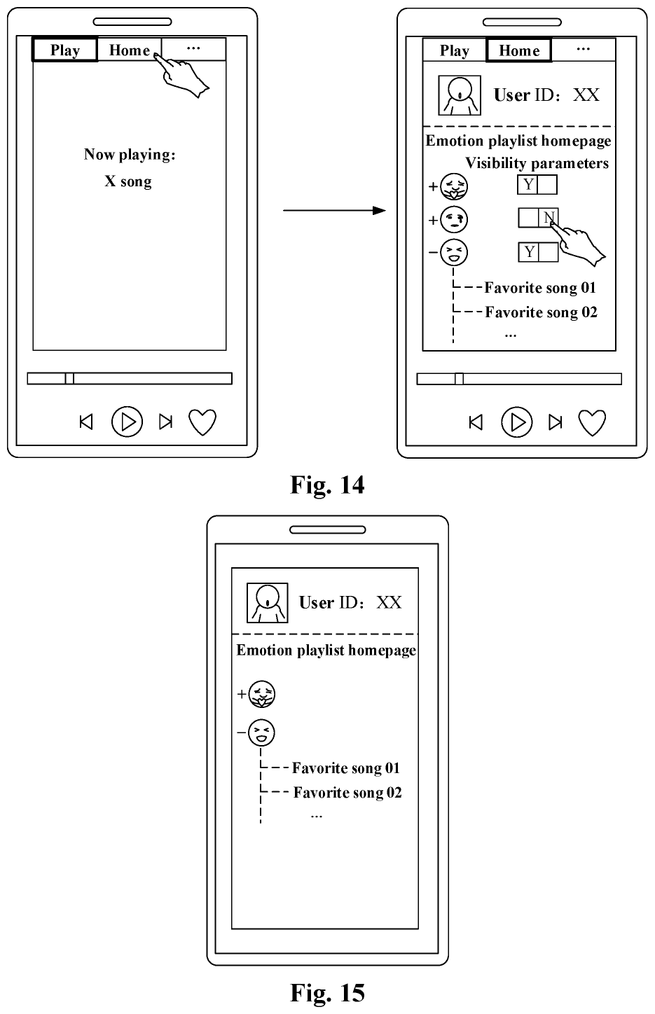

Exemplarily, after the APP runs, the terminal device receives the fifth interactive operation input by the user, so as to display the emotion playlist homepage (i.e., an emotion media collection homepage), where the emotion playlist homepage is a page used for displaying at least one emotion playlist to other users, and more specifically, the emotion playlist homepage, for example, may be a user homepage, a user profile page, etc. FIG. 14 is a schematic diagram of an emotion playlist homepage according to an embodiment of the disclosure. As shown in FIG. 14, an emotion playlist homepage control (i.e., an emotion media collection homepage control denoted by “Homepage” in the figure) for navigating to the emotion playlist homepage is set within the APP, and meanwhile a control (denoted by “Play” in the figure) for navigating to a play page is further set. The fifth interactive operation is a tap operation for the emotion playlist homepage control. After tapping on the emotion playlist homepage control, the corresponding emotion playlist homepage is displayed, where the emotion playlist homepage may include user data such as user ID and a photo, and further includes a plurality of emotion playlists. By performing the interactive operations such as the tap operation (e.g., by tapping on “+” and “−” in the figure), favorite songs within the emotion playlists and visibility parameters corresponding to each emotion playlist can be displayed or hidden. Exemplarily, the visibility parameters include: “visible to other users” (denoted by “Y” in the figure) and “invisible to other users” (denoted by “N” in the figure). When the visibility parameter is set to “Y”, other users who access the emotion playlist homepage of the current user can see the emotion playlist corresponding to the visibility parameter. When the visibility parameter is set to “N,” other users who access the emotion playlist homepage of the current user cannot see the emotion playlist corresponding to the visibility parameter.

Further, in a possible implementation, the fifth interactive operation may also be an operation for accessing an emotion playlist homepage of another user, such as the tap operation for navigating to the emotion playlist homepage of the another user. Specifically, the specific steps for navigating to the emotion playlist homepage of the another user based on the fifth interactive operation include: recommended song information includes an emotion playlist homepage access address of a target user, and navigation is performed to the emotion playlist homepage of the target user based on the recommended song information and the fifth interactive operation. The specific method for obtaining the recommended song information is introduced in the embodiment shown in FIG. 8, which is not further described herein.

Step S304: in response to a sixth interactive operation, visibility parameters of the emotion playlists within the emotion playlist homepage are set, and the visibility parameters represent visibility of the emotion playlists to other users when other users access the emotion playlist homepage.

Further, refer to the schematic diagram of the emotion playlist homepage shown in FIG. 14, the sixth interactive operation is an operation for the visibility parameters of the emotion playlists, such as the tap operation. Through the sixth interactive operation, the visibility parameter may be set to “Y” (i.e., visible to other users) or “N” (invisible to other users). Exemplarily, the default visibility parameter for the emotion playlists is set to “Y”. As shown in FIG. 14, through the tap operation (the sixth interactive operation), the visibility parameter of the emotion playlist corresponding to the emotion of sadness is set to “N”, such that the emotion playlist is not displayed to other users who access the emotion playlist homepage.

FIG. 15 is a schematic diagram illustrating the access of an emotion playlist homepage by other users according to an embodiment of the disclosure. As shown in FIG. 15, after the current user sets the visibility parameters of the emotion playlist homepage based on the sixth interactive operation, the emotion playlist set in a state of “invisible to other users” (i.e., the emotion playlist with the visibility parameter set to “N”) will not be displayed on the emotion playlist homepage of the current user to which other users have access. The emotion playlist homepage of the current user only displays the emotion playlists set in a state of “visible to other users” (i.e., the emotion playlists with the visibility parameter set to “Y”) and favorite songs within the emotion playlists.

In this embodiment, because the emotion playlists are generated based on the emotional perceptions of the users, the emotion playlists have certain reference functions and propagative characteristics for users with similar emotional perception traits. Therefore, the emotion playlist homepage used for displaying the emotion playlists may realize the social functionality of the APP in the application scenario of the Internet products, thereby improving the positivity of the users in interactive access. Moreover, based on the visibility parameter settings of the emotion playlist homepage, the user privacy can be ensured to a certain degree in the interactive access process of the users, thereby satisfying the privacy requirements of the users.

It should be noted that Embodiment 2 shown in FIG. 8 in the disclosure is a further refinement and extension of Embodiment 1 shown in FIG. 2, and therefore, the method provided in this embodiment may also be used in conjunction with the embodiment shown in FIG. 8. In addition to the order of execution listed in this embodiment, the method steps related to the emotion playlist homepage provided in this embodiment may be performed before or after any step in the embodiment shown in FIG. 2 or FIG. 8, and no further examples will be given herein.

The specific implementation of step S301 to step S302 in this embodiment are described in detail in the embodiments shown in FIG. 2 and FIG. 8, which is not further described herein.

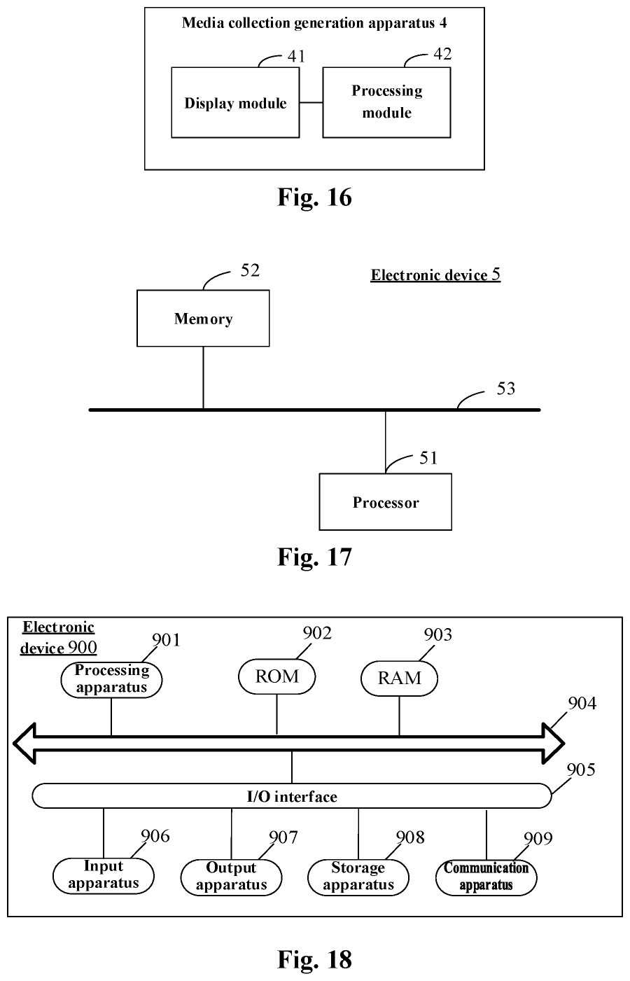

Corresponding to the media collection generation method in the above embodiments, FIG. 16 is a structural block diagram of a media collection generation apparatus according to an embodiment of the disclosure. To facilitate the description, only the parts related to this embodiment of the disclosure are shown. Referring to FIG. 16, the media collection generation apparatus 4 includes:
a display module 41, configured to display a plurality of emotion identifications within a playback interface of target media, the emotion identifications being used for representing preset emotion types; and
a processing module 42, configured to add, in response to a first interactive operation for a target emotion identification, the target media to a target emotion media collection corresponding to the target emotion identification.

In a possible implementation, the display module 41 is further configured to display or play, in response to a second interactive operation for the target emotion media collection, media within collections belonging to the target emotion media collection.

In a possible implementation, after displaying the media within collections belonging to the target emotion media collection, the processing module 42 is further configured to remove, in response to a third interactive operation for the media within a target collection from the target emotion media collection, the media within the target collection from the target emotion media collection, or change the playback order, within the target emotion media collection, of the media within the target collection.

In a possible implementation, when the processing module 42 adds, in response to the first interactive operation for the target emotion identification, the target media to the target emotion media collection corresponding to the target emotion identification, the display module 41 is specifically configured to display, in response to the first interactive operation for the target emotion identification, a custom media collection list, the custom media collection list including at least one custom media collection; and the processing module 42 is specifically configured to add, in response to a tap operation for a target custom media collection, the target media to a target emotion media collection corresponding to the target emotion identification within the target custom media collection.

In a possible implementation, the display module 41 is further configured to display, in response to a second interactive operation for the target custom media collection, at least one emotion media collection belonging to the target custom media collection; and play, in response to a tap operation for the target emotion media collection within the at least one emotion media collection, media within the collections belonging to the selected target emotion media collection.

In a possible implementation, the playback interface is provided with a favorite control, and the favorite control is configured to favorite the target media after being triggered.

When displaying the plurality of emotion identifications within the playback interface of the target media, the display module 41 is specifically configured to display, in response to a fourth interactive operation for the favorite control, the plurality of emotion identifications, where the fourth interactive operation is different from a trigger operation corresponding to the favorite control, and includes one of the following: long press, double tap, and swipe.

In a possible implementation, the processing module 42 is further configured to send the target emotion media collection, such that a target user obtains recommended media, where the target user is a user having a similar emotion media collection, the similar emotion media collection is an emotion media collection corresponding to the target emotion identification and including media within at least one collection from the target emotion media collection, and the recommended media is the media within collections, which is within the target emotion media collection but not within the similar emotion media collection.

In a possible implementation, the processing module 42 is further configured to receive and display recommended media information from a target user, where the target user is a user having a similar emotion media collection, the similar emotion media collection is an emotion media collection corresponding to the target emotion identification and including media within at least one collection from the target emotion media collection, and the recommended media is the media within collections, which is within the similar emotion media collection but not within the target emotion media collection.

In a possible implementation, the display module 41 is further configured to display, in response to a fifth interactive operation, an emotion media collection homepage; and the processing module 42 is further configured to edit, in response to a sixth interactive operation, the emotion media collection homepage, the emotion media collection homepage being used for displaying an emotion media collection corresponding to at least one emotion identification to other users.

In a possible implementation, when editing, in response to the sixth interactive operation, the emotion media collection homepage, the processing module 42 is specifically configured to set, in response to the sixth interactive operation, visibility parameters of emotion media collections within the emotion media collection homepage, the visibility parameters representing visibility of the emotion media collections to other users when other users access the emotion media collection homepage.

The display module 41 is connected with the processing module 42. The media collection generation apparatus 4 provided in this embodiment may perform the technical solutions in the above method embodiments, and the implementation principle and technical effects are similar to those as above, which are not further described in this embodiment.

FIG. 17 is a structural schematic diagram of an electronic device according to an embodiment of the disclosure. As shown in FIG. 17, the electronic device 5 includes:
a processor 51, and a memory 52 which is in communication connection with the processor 51.

The memory 52 stores computer executable instructions.

The processor 51 executes the computer executable instructions stored on the memory 52 so as to implement the media collection generation method in the embodiments shown in FIG. 2 to FIG. 15.

Optionally, the processor 51 and the memory 52 are connected through a bus 53.

The relevant explanations may be understood by referring to the relevant descriptions and effects corresponding to the steps in the embodiments corresponding to FIG. 2 to FIG. 15, which are not further described herein.

Referring to FIG. 18, FIG. 18 illustrates a structural schematic diagram of an electronic device 900 applicable to implementing the embodiments of the disclosure. The electronic device 900 may be a terminal device or a server. The terminal device may include but not limited to mobile terminals such as a mobile phone, a notebook computer, a digital radio receiver, a personal digital assistant (PDA), a portable Android device (PAD), a portable media player (PMP), a vehicle-mounted terminal (e.g., a vehicle-mounted navigation terminal), and fixed terminals such as a digital TV and a desk computer. The electronic device shown in FIG. 18 is merely an example, which should not impose any limitations on functions and application ranges of this embodiment of the disclosure.

As shown in FIG. 18, the electronic device 900 may include a processing apparatus (e.g., a central processing unit and a graphics processing unit) 901, which may perform various appropriate actions and processing according to programs stored on a read only memory (ROM) 902 or loaded from a storage apparatus 908 into a random access memory (RAM) 903. The RAM 903 further stores various programs and data required for the operation of the electronic device 900. The processing apparatus 901, the ROM 902, and the RAM 903 are connected to one another through a bus 904. An input/output (I/O) interface 905 is also connected to the bus 904.

Typically, the following apparatuses may be connected to the I/O interface 905: an input apparatus 906, such as a touchscreen, a touchpad, a keyboard, a mouse, a camera, a microphone, an accelerometer, and a gyroscope; an output apparatus 907, such as a liquid crystal display (LCD), a speaker, and a vibrator; the storage apparatus, such as a magnetic tape and a hard drive; and a communication apparatus 909. The communication apparatus 909 may allow the electronic device 900 to be in wireless or wired communication with other devices for data exchange. Although FIG. 18 illustrates the electronic device 900 with various apparatuses, it should be understood that it is not necessary to implement or have all the shown apparatuses. Alternatively, more or fewer apparatuses may be implemented or provided.

Particularly, the foregoing process described with reference to the flowchart according to the embodiments of the disclosure may be implemented as a computer software program. For example, an embodiment of the disclosure includes a computer program product including a computer program stored on a computer-readable medium. The computer program includes program code for executing the method shown in the flowchart. In this embodiment, the computer program may be downloaded and installed from the network by the communication apparatus 909, or installed from the storage apparatus 908, or installed from the ROM 902. The computer program, when executed by the processing apparatus 901, performs the above functions limited in the method in this embodiment of the disclosure.

It should be noted that the computer-readable medium in the disclosure may be a computer-readable signal medium, or a computer-readable storage medium, or any combination thereof. For example, the computer-readable storage medium may include but not limited to: electrical, magnetic, optical, electromagnetic, infrared or semiconductor systems, apparatuses or devices, or any combination thereof. More specific examples of the computer-readable storage medium may include but not limited to: an electrical connection with one or more wires, a portable computer disk, a hard drive, a random access memory (RAM), a read only memory (ROM), an erasable programmable read only memory (EPROM or a flash memory), fiber optics, a portable compact disc read only memory (CD-ROM), a light storage device, a magnetic storage device, or any proper combination of the above. In the disclosure, the computer-readable storage medium may be any tangible medium including or storing a program, and the program may be used by an instruction execution system, apparatus or device, or used in conjunction with the instruction execution system, apparatus or device. However, in the disclosure, the computer-readable signal medium may include data signals propagated in a baseband or propagated as a part of a carrier wave, which carry computer-readable program code. The propagated data signals may have a plurality of forms, and include but not limited to electromagnetic signals, optical signals or any proper combination of the above. The computer-readable signal medium may be any computer-readable medium other than the computer-readable storage medium. The computer-readable signal medium may send, propagate or transmit the program used by the instruction execution system, apparatus or device, or used in conjunction with the instruction execution system, apparatus or device. The program code included in the computer-readable medium may be transmitted by any proper medium including but not limited to a wire, an optical cable, radio frequency (RF), etc., or any proper combination of the above.

The computer-readable medium may be included in the electronic device; and may separately exist without being assembled in the electronic device.

The computer-readable medium carries one or more programs. The one or more programs, when executed by the electronic device, enable the electronic device to perform the method shown in the above embodiments.

The computer program code for executing the operations of the disclosure may be written in one or more programming languages or a combination thereof. The programming languages include object-oriented programming languages such as Java, Smalltalk, C++, as well as conventional procedural programming languages such as “C” or similar programming languages. The program code may be executed entirely or partially on a user computer, executed as a standalone software package, executed partially on the user computer and partially on a remote computer, or entirely executed on the remote computer or server. In the case of involving the remote computer, the remote computer may be connected to the user computer via any type of network, including a local area network (LAN) or wide area network (WAN), or may be connected to an external computer (e.g., utilizing an Internet service provider for Internet connectivity).

The flowcharts and block diagrams in the accompanying drawings illustrate system architectures, functions, and operations possibly implemented by the system, method and computer program product according to the various embodiments of the disclosure. In this regard, each block in the flowcharts or block diagrams may represent a module, a program segment, or a portion of the code, and the module, program segment, or portion of the code includes one or more executable instructions for implementing specified logical functions. It should be noted that in some alternative implementations, functions marked in the blocks may also occur in an order different from that marked in the accompanying drawings. For example, two consecutively-represented blocks may actually be executed in parallel basically, but sometimes may also be executed in a reverse order, which depends on involved functions. It should be further noted that each block in the block diagrams and/or flowcharts as well as a combination of the blocks in the block diagrams and/or flowcharts may be implemented by using a dedicated hardware-based system that executes specified functions or operations, or using a combination of special hardware and computer instructions.

The units described in the embodiments of the disclosure may be implemented through software or hardware. The name of the unit does not limit the unit in certain cases. For example, a first acquisition unit may also be described as a “unit for acquiring at least two Internet protocol addresses.”

The functions described above in this specification may be at least partially executed by one or more hardware logic components. For example, exemplary hardware logic components that can be used include but not limited to a field-programmable gate array (FPGA), an application specific integrated circuit (ASIC), application specific standard parts (ASSPs), a system on chip (SOC), a complex programmable logic device (CPLD), etc.

In the context of the disclosure, a machine-readable medium may be a tangible or non-transitory medium that may contain or store a program, and the program may be used by an instruction execution system, apparatus or device, or used in conjunction with the instruction execution system, apparatus or device. The machine-readable medium may be a machine-readable signal medium or a machine-readable storage medium. The machine-readable medium may include but not limited to: electronic, magnetic, optical, electromagnetic, infrared, or semiconductor systems, apparatuses or devices, or any proper combination of the above. More specific examples of the machine-readable storage medium may include: an electrical connection based on one or more wires, a portable computer disk, a hard drive, a random access memory (RAM), a read only memory (ROM), an erasable programmable read only memory (EPROM or a flash memory), fiber optics, a portable compact disc read only memory (CD-ROM), a light storage device, a magnetic storage device, or any proper combination of the above.

In a first aspect, according to one or more embodiments of the disclosure, a media collection generation method is provided, and includes:
a plurality of state identifications are displayed within a playback interface of target media, and the state identifications are used for representing preset state types; and in response to a first interactive operation for a target state identification, the target media is added to a target state media collection corresponding to the target state identification.

According to one or more embodiments of the disclosure, the method further includes: in response to a second interactive operation for the target state media collection, media within collections belonging to the target state media collection is displayed or played.

According to one or more embodiments of the disclosure, after displaying the media within collections belonging to the target state media collection, the method further includes: in response to a third interactive operation for the media within a target collection from the target state media collection, the media within the target collection is removed from the target state media collection, or the playback order, within the target state media collection, of the media within the target collection is changed.

According to one or more embodiments of the disclosure, the step of adding, in response to a first interactive operation for a target state identification, the target media to a target state media collection corresponding to the target state identification includes: in response to the first interactive operation for the target state identification, a custom media collection list is displayed, and the custom media collection list includes at least one custom media collection; and in response to a tap operation for a target custom media collection, the target media is added to a target state media collection corresponding to the target state identification within the target custom media collection.

According to one or more embodiments of the disclosure, the method further includes: in response to the second interactive operation for the target custom media collection, at least one state media collection belonging to the target custom media collection is displayed; and in response to a tap operation for the target state media collection within the at least one state media collection, media within the collections belonging to the selected target state media collection is played.

According to one or more embodiments of the disclosure, the playback interface is provided with a favorite control, and the favorite control is configured to favorite the target media after being triggered. The step of displaying a plurality of state identifications within a playback interface of target media includes: in response to a fourth interactive operation for the favorite control, the plurality of state identifications are displayed, where the fourth interactive operation is different from a trigger operation corresponding to the favorite control, and the fourth interactive operation includes one of the following: long press, double tap, and swipe.

According to one or more embodiments of the disclosure, the method further includes: the target state media collection is sent, such that a target user obtains recommended media, where the target user is a user having a similar state media collection, the similar state media collection is a state media collection corresponding to the target state identification and including media within at least one collection from the target state media collection, and the recommended media is the media within collections, which is within the target state media collection but not within the similar state media collection.

According to one or more embodiments of the disclosure, the method further includes: recommended media information from a target user is received and displayed, where the target user is a user having a similar state media collection, the similar state media collection is a state media collection corresponding to the target state identification and including media within at least one collection from the target state media collection, and the recommended media is the media within collections, which is within the similar state media collection but not within the target state media collection.

According to one or more embodiments of the disclosure, the method further includes: in response to a fifth interactive operation, a state media collection homepage is displayed, or, in response to a sixth interactive operation, the state media collection homepage is edited, where the state media collection homepage is used for displaying a state media collection corresponding to at least one state identification to other users.

According to one or more embodiments of the disclosure, the step of editing, in response to a sixth interactive operation, the state media collection homepage includes: in response to the sixth interactive operation, visibility parameters of state media collections within the state media collection homepage are set, and the visibility parameters represent visibility of the state media collections to other users when other users access the state media collection homepage.

In a second aspect, according to one or more embodiments of the disclosure, a media collection generation apparatus is provided, and includes:
a display module, configured to display a plurality of state identifications within a playback interface of target media, the state identifications being used for representing preset state types; and
a processing module, configured to add, in response to a first interactive operation for a target state identification, the target media to a target state media collection corresponding to the target state identification.

According to one or more embodiments of the disclosure, the display module is further configured to display or play, in response to a second interactive operation for the target state media collection, media within collections belonging to the target state media collection.

According to one or more embodiments of the disclosure, after displaying the media within collections belonging to the target state media collection, the processing module is further configured to remove, in response to a third interactive operation for media within a target collection from the target state media collection, the media within the target collection from the target state media collection, or change the playback order, within the target state media collection, of the media within the target collection.

According to one or more embodiments of the disclosure, when the processing module adds, in response to the first interactive operation for the target state identification, the target media to the target state media collection corresponding to the target state identification, the display module is specifically configured to display, in response to the first interactive operation for the target state identification, a custom media collection list, the custom media collection list including at least one custom media collection; and the processing module is specifically configured to add, in response to a tap operation for a target custom media collection, the target media to a target state media collection corresponding to the target state identification within the target custom media collection.

According to one or more embodiments of the disclosure, the display module is further configured to display, in response to a second interactive operation for the target custom media collection, at least one state media collection belonging to the target custom media collection; and play, in response to a tap operation for a target state media collection within the at least one state media collection, media within collections belonging to the selected target state media collection.

According to one or more embodiments of the disclosure, the playback interface is provided with a favorite control, and the favorite control is configured to favorite the target media after being triggered.

When displaying the plurality of state identifications within the playback interface of the target media, the display module is specifically configured to display, in response to a fourth interactive operation for the favorite control, the plurality of state identifications, where the fourth interactive operation is different from a trigger operation corresponding to the favorite control, and includes one of the following: long press, double tap, and swipe.

According to one or more embodiments of the disclosure, the processing module is further configured to send the target state media collection, such that a target user obtains recommended media, where the target user is a user having a similar state media collection, the similar state media collection is a state media collection corresponding to the target state identification and including media within at least one collection from the target state media collection, and the recommended media is the media within collections, which is within the target state media collection but not within the similar state media collection.

According to one or more embodiments of the disclosure, the processing module is further configured to receive and display recommended media information from a target user, where the target user is a user having a similar state media collection, the similar state media collection is a state media collection corresponding to the target state identification and including media within at least one collection from the target state media collection, and the recommended media is the media within collections, which is within the similar state media collection but not within the target state media collection.

According to one or more embodiments of the disclosure, the display module is further configured to display, in response to a fifth interactive operation, a state media collection homepage; and the processing module is further configured to edit, in response to a sixth interactive operation, the state media collection homepage, where the state media collection homepage is used for displaying a state media collection corresponding to at least one state identification to other users.

According to one or more embodiments of the disclosure, when editing, in response to the sixth interactive operation, the state media collection homepage, the processing module is specifically configured to set, in response to the sixth interactive operation, visibility parameters of the state media collections within the state media collection homepage, where the visibility parameters represent visibility of the state media collections to other users when other users access the state media collection homepage.

In a third aspect, according to one or more embodiments of the disclosure, an electronic device is provided, and includes a processor, and a memory which is in communication connection with the processor.

The memory stores computer executable instructions.

The processor executes the computer executable instructions stored on the memory so as to implement the media collection generation method in the first aspect and various possible designs in the first aspect.

In a fourth aspect, according to one or more embodiments of the disclosure, a non-transitory computer-readable storage medium is provided. The computer-readable storage medium stores computer executable instructions. When a processor executes the computer executable instructions, the media collection generation method according to the first aspect and various possible designs in the first aspect is implemented.

In a fifth aspect, an embodiment of the disclosure provides a computer program product, including a computer program. The computer program, when executed by a processor, implements the media collection generation method according to the first aspect and various possible designs in the first aspect.

In a sixth aspect, an embodiment of the disclosure provides a computer program. The computer program, when executed by a processor, implements the media collection generation method according to the first aspect and various possible designs in the first aspect.

The above descriptions are merely preferred embodiments of the disclosure and explanations of the applied technical principles. Those skilled in the art should understand that the scope of open in the disclosure is not limited to the technical solutions formed by specific combinations of the above technical features, and also covers other technical solutions formed by arbitrary combinations of the above technical features or equivalent features without departing from the concept of the disclosure, such as a technical solution formed by replacing the above features with the technical features with similar functions disclosed (but not limited to) in the disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the disclosure. Certain features described in the context of separate embodiments may also be implemented in combination in a single embodiment. Conversely, various features described in the context of a single embodiment may also be implemented separately or in any suitable sub-combination in a plurality of embodiments.

Although the language for structural features and/or method logical actions is adopted to describe this subject, but it should be understood that the subject limited in the appended claims is not necessarily limited to the specific features or actions described above. On the contrary, the specific features and actions described above are merely examples for implementing the claims.

1. A media collection generation method, comprising:
displaying a plurality of state identifications within a playback interface of target media, the state identifications being used for representing preset state types; and
adding, in response to a first interactive operation for a target state identification, the target media to a target state media collection corresponding to the target state identification.

2. The method according to claim 1, wherein the method further comprises:
displaying or playing, in response to a second interactive operation for the target state media collection, media within collections belonging to the target state media collection.

3. The method according to claim 2, wherein after displaying media within collections belonging to the target state media collection, the method further comprises:
removing, in response to a third interactive operation for a media within a target collection of the target state media collection, the media within the target collection from the target state media collection, or changing a playback order, within the target state media collection, of the media within the target collection.

4. The method according to claim 1, wherein adding, in response to a first interactive operation for a target state identification, the target media to a target state media collection corresponding to the target state identification comprises:
displaying, in response to the first interactive operation for the target state identification, a custom media collection list, the custom media collection list comprising at least one custom media collection; and
adding, in response to a tap operation for a target custom media collection, the target media to a target state media collection corresponding to the target state identification within the target custom media collection.

5. The method according to claim 4, wherein the method further comprises:
displaying, in response to a second interactive operation for the target custom media collection, at least one state media collection belonging to the target custom media collection; and
playing, in response to a tap operation for a target state media collection within the at least one state media collection, media within collections belonging to the selected target state media collection.

6. The method according to claim 1, wherein the playback interface is provided with a favorite control, and the favorite control is configured to favorite the target media after being triggered; and
the displaying a plurality of state identifications within a playback interface of target media comprises:
displaying, in response to a fourth interactive operation for the favorite control, the plurality of state identifications, wherein the fourth interactive operation is different from a trigger operation corresponding to the favorite control,
the fourth interactive operation comprises one of the following: long press, double tap, and swipe.

7. The method according to claim 1, wherein the method further comprises:
sending the target state media collection, such that a target user obtains recommended media, wherein the target user is a user having a similar state media collection, the similar state media collection is a state media collection corresponding to the target state identification and comprising media within at least one collection of the target state media collection, and the recommended media is media within collections that is within the target state media collection and not within the similar state media collection.

8. The method according to claim 1, wherein the method further comprises:
receiving and displaying recommended media information from a target user, wherein the target user is a user having a similar state media collection, the similar state media collection is a state media collection corresponding to the target state identification and comprising media within at least one collection of the target state media collection, and the recommended media is media within collections that is within the similar state media collection and not within the target state media collection.

9. The method according to claim 1, wherein the method further comprises:
displaying, in response to a fifth interactive operation, a state media collection homepage, or,
editing, in response to a sixth interactive operation, the state media collection homepage,
the state media collection homepage being used for displaying a state media collection corresponding to at least one state identification to other users.

10. The method according to claim 9, wherein the editing, in response to a sixth interactive operation, the state media collection homepage comprises:
setting, in response to the sixth interactive operation, visibility parameters of the state media collections within the state media collection homepage, the visibility parameters representing visibility of the state media collections to other users when the state media collection homepage being accessed by the other users.

11. (canceled)

12. An electronic device, comprising: a processor, and a memory which is in communication connection with the processor,
the memory storing computer executable instructions, and
the processor executing the computer executable instructions stored on the memory and causing the electronic device to:
display a plurality of state identifications within a playback interface of target media, the state identifications being used for representing preset state types; and
add, in response to a first interactive operation for a target state identification, the target media to a target state media collection corresponding to the target state identification.

13. A computer-readable storage medium, wherein the computer-readable storage medium stores computer executable instructions which cause the processor to:
display a plurality of state identifications within a playback interface of target media, the state identifications being used for representing preset state types; and
add, in response to a first interactive operation for a target state identification, the target media to a target state media collection corresponding to the target state identification.

14. (canceled)

15. (canceled)

16. The electronic device of claim 12, further comprises:
display or play, in response to a second interactive operation for the target state media collection, media within collections belonging to the target state media collection.

17. The electronic device to claim 16, wherein after display media within collections belonging to the target state media collection, further comprises:
remove, in response to a third interactive operation for a media within a target collection of the target state media collection, the media within the target collection from the target state media collection, or change a playback order, within the target state media collection, of the media within the target collection.

18. The electronic device according to claim 16, wherein add, in response to a first interactive operation for a target state identification, the target media to a target state media collection corresponding to the target state identification comprises:
display, in response to the first interactive operation for the target state identification, a custom media collection list, the custom media collection list comprising at least one custom media collection; and
add, in response to a tap operation for a target custom media collection, the target media to a target state media collection corresponding to the target state identification within the target custom media collection.

19. The electronic device according to claim 18, further comprises:
display, in response to a second interactive operation for the target custom media collection, at least one state media collection belonging to the target custom media collection; and
play, in response to a tap operation for a target state media collection within the at least one state media collection, media within collections belonging to the selected target state media collection.

20. The electronic device according to claim 16, wherein the playback interface is provided with a favorite control, and the favorite control is configured to favorite the target media after being triggered; and
the display a plurality of state identifications within a playback interface of target media comprises:
display, in response to a fourth interactive operation for the favorite control, the plurality of state identifications, wherein the fourth interactive operation is different from a trigger operation corresponding to the favorite control,
the fourth interactive operation comprises one of the following: long press, double tap, and swipe.

21. The electronic device according to claim 16, wherein further comprises:
send the target state media collection, such that a target user obtains recommended media, wherein the target user is a user having a similar state media collection, the similar state media collection is a state media collection corresponding to the target state identification and comprising media within at least one collection of the target state media collection, and the recommended media is media within collections that is within the target state media collection and not within the similar state media collection.

22. The electronic device according to claim 16, further comprises:
receive and display recommended media information from a target user, wherein the target user is a user having a similar state media collection, the similar state media collection is a state media collection corresponding to the target state identification and comprising media within at least one collection of the target state media collection, and the recommended media is media within collections that is within the similar state media collection and not within the target state media collection.

23. The electronic device according to claim 16, wherein the acts further comprises:
display, in response to a fifth interactive operation, a state media collection homepage, or,
edit, in response to a sixth interactive operation, the state media collection homepage,
the state media collection homepage is used for displaying a state media collection corresponding to at least one state identification to other users.
